(19) United States
(12) Patent Application Publication
(10) Pub. No.: US 2014/0057604 A1
(43) Pub. Date: Feb. 27, 2014

(54) METHOD FOR PROVIDING OPERATING INSTRUCTIONS AND USER INSTRUCTIONS BELONGING TO A TECHNICAL DEVICE

(71) Applicant: Timothy KOLANOWSKI, Auburn Hills, MI (US)

(72) Inventor: Timothy KOLANOWSKI, Auburn Hills, MI (US)

(73) Assignee: CONTINENTAL REIFEN DEUTSCHLAND GMBH, Hannover (DE)

(21) Appl. No.: 13/591,964

(22) Filed: Aug. 22, 2012

(51) Int. Cl. H04W 4/00

(52) U.S. Cl. 455/412.1

(57) ABSTRACT

A method for providing operating instructions and user instructions belonging to a technical device, in which a visualization takes place on a screen of a mobile phone, wherein the operating instructions and user instructions are stored in a remote storage device accessible via the telecommunications device and that the technical device has a character string that can be transmitted to the remote storage device via the telecommunications device, which character string, after the transmission, triggers a remote transmission of the operating instructions and user instructions to the display device of the telecommunications device.

### BACKGROUND OF THE INVENTION

1. Field of the Invention

The invention relates to a method for providing operating instructions and user instructions associated with a technical device for the operation thereof, and for the transmission and display of the operating instructions and user instructions on a telecommunications device.

2. Discussion of Background Information

Operating instructions and user instructions for the correct operation of a technical device is generally provided as a booklet or brochure accompanying the technical device at the time of purchase or afterwards from the manufacture or distributor of the technical device. The booklet can include textual information (in one or more languages), illustrations, photographs, etc., to assist the user in the correct operation and use of the technical device. Further, operating instructions can also be provided on the technical device or on a casing or housing of the technical device, e.g., adhered via a sticker, to provide text and/or illustrations showing the proper set-up and/or operation of the technical device.

In the case of comprehensive instruction booklets for operation, which can include text translated into a number of foreign languages and which can also include annotated illustrations and/or photos also translated into a number of foreign languages, the operating instructions can become very long and cumbersome. Due to a lack of space, such comprehensive operating instructions may often be stored a distance from the technical device to which they associated. This can be particularly disadvantageous in the event the user, unfamiliar with the operation of the technical device, is away from the location in which the comprehensive operating instructions are stored and requires instructions to operate the technical device. Moreover, even if the comprehensive operating instructions are available to the user, finding the applicable pages of the manual required by the user may be difficult given the number of pages and number of languages printed in the manual.

### SUMMARY OF THE EMBODIMENTS

Therefore, embodiments of the invention provide an easy to use method and apparatus for obtaining operating instructions and user instructions associated with or belonging to a technical device to assist the user in the proper operation of the technical device on a telecommunications device. In particular, operating instructions for the technical device can be downloaded for display on a telecommunications device in response to the transmission and/or scanning of a code.

The operating instructions and user instructions may be stored in a remote storage device accessible via the telecommunications device for transmission to and display on the telecommunications device. By way of non-limiting example, the technical device or a portion of the technical device can have printed or affixed thereon a character string to be transmitted via the telecommunications device to the remote storage device. The character string received at the remote storage device may trigger a remote transmission of the operating instructions and user instructions to a display device of the telecommunications device.

The character string printed, adhered or otherwise attached to the device can be, e.g., letters, numbers or a combination of letters and numbers, that can be transmitted orally through a receiver or microphone integrated with or coupled to the telecommunications device or via keystrokes on a keyboard integrated with or coupled to the telecommunication device, which can be a mobile device, such as a mobile telephone, smartphone, IPhone, a mobile computer, IPad, tablet computer, etc., to a receiver device that is connected to a corresponding computer that includes the storage device on which the operating instructions and user instructions are stored as a file, e.g., a video, voice recording, graphical illustration, text file, etc. The transmission from the telecommunications device can be sent through via the Internet and/or via one or more wireless and/or wired public or private networks to the receiver device. Moreover, the corresponding computer of the receiver device can include voice recognition software for transmitting the received voice transmission data, as well as software for additionally or alternatively receiving the character data string input through the keyboard of telecommunications device and transmitting data associated with the received character string to the receiving device so that the received character string input data can be decoded in order to identify the storage location for the operating instructions and user instructions requested by the user.

In other embodiments, in addition to or as an alternative to the visualization of the operating instructions and user instructions being displayed by the telecommunications device, an audible presentation of the operating instructions and user instructions, e.g., transmission of a recorded message/instructions, can be initiated to from the receiver device to the telecommunications device. In this manner, the user can, e.g., concurrently listen to the instructions and perform the instructions without having to find and read the operating instructions. Likewise, an embodiment of this type is well suited to the case that the user is visually impaired and/or is unable to read and/or understand the textual instructions.

A further simplifying advantageous embodiment lies in that the character string may be embodied or formed as a machine-readable code, e.g., a bar code or quick response (QR) code. In such an embodiment, a digital image collector/receiver, e.g., a digital (preferably still) camera and/or a scanner may be integrated with or connected to the telecommunications device to capture an image of the bar code or QR code. Moreover, through software that can be stored on the telecommunications device, a data link associated with the received digital image of the bar code or QR code may be displayed on the telecommunications device for the user to access and retrieve the operating instructions and user instructions stored in the remote storage device. Further, it is also contemplated that, rather than providing a link to the data stored on the remote storage device, once the image of the bar code or QR code is captured by the digital image collector/receiver, the data stored on the remote storage device is transmitted to the telecommunications device. In accordance with this embodiment, manual entry of the character string becomes unnecessary, whereby user error can essentially be eliminated. This may be particularly advantageous when the technical device is, e.g., a safety and/or rescue device.

A further advantageous embodiment provides the visualization or visual display of the operating instructions being carried out by a video sequence that can be played on the display device of the telecommunications device. In this way, the user's understanding of the instructions can be enhanced through the pictorial (video) rendition of the performance of the instructions and misinterpretations of the instructions can generally be avoided.

In a further advantageous embodiment, an application or, as more commonly known, an “app” stored on the telecommunications device, e.g., a mobile phone, smartphone, IPhone, IPad, mobile computer, tablet computer, etc., can undertake performance of the transmission, remote transmission, audible presentation and visualization of the operating instructions and user instructions. The app, which can be available at no cost, for cost, or as part of a subscription, can be stored on the telecommunications device in accordance with the specific device parameters in order to be accessed by the user via a touchscreen of the telecommunications device. In this manner, it is possible to leverage the currently high market penetration of smartphones so that accessing an “app” on the telecommunications device can be sufficient to initialize the presentation and visualization of the operating instructions.

For the corresponding technical devices all data for the operation are then available in the remote storage device on an external server. The user of the application selects the type of presentation of the operating instructions, i.e., video, text or voice file, via a menu guide. A direct updating of the operating instructions and user instructions is possible at any time and worldwide.

A further advantageous embodiment lies in that the audible presentation and the visualization of the operating instructions and user instructions are carried out in a language/foreign language that can be selected via the telecommunications device. Instructions in different languages, as are necessary, for example, with devices that are supplied to a number of different countries or language areas, can thus be easily provided.

Particularly advantageously the method can be used with a device for sealing and inflating inflatable objects, in particular with a puncture kit for sealing and inflating motor vehicle tires, since here a facilitation can be achieved in that the operating instructions and user instructions necessary for this operation do not need to be searched for in addition to the device at inaccessible locations in the vehicle, nor are they dirty.

A further advantageous embodiment of a use of this type lies in that the character string on the device also contains an indexing that, depending on the age, the condition of use or special production features, inserts additional instructions in the operating instructions and user instructions. This ensures the instructions are up-to-date as well as, for instance, cautions in the case of older device parts or associated sealants as well as information about the replacement or reordering of device parts worn out with use.

In embodiments, a method provides at least one of operating instructions and user instructions associated with a technical device and necessary for the operation thereof, in which a visualization of the operating instructions and user instructions on a display device of a telecommunications device takes place, in particular on the screen of a mobile phone or a portable PC. According to the method, the operating instructions and user instructions can be stored in a remote storage device accessible via the telecommunications device and the technical device can have a code or character string that can be transmitted to the remote storage device via the telecommunications device. The code or character string, after the transmission, can trigger a remote transmission of the operating instructions and user instructions to the display device of the telecommunications device.

In further embodiments, in addition to or instead of the visualization with the aid of the telecommunications device, an audible presentation of the operating instructions and user instructions can take place. Further, the audible presentation and the visualization of the operating instructions and user instructions can be carried out in a language that can be selected via the telecommunications device.

The code or character string may be embodied as a machine-readable code, in particular as a bar code or quick response code (QR code), and the telecommunications device may be equipped with a still camera or a scanner so that the bar code or the QR code can be read by the still camera or the scanner and transmitted to the remote storage device.

In other embodiments, the visualization of the operating instructions can be carried out by a video sequence that can be played on the display device.

According to still other embodiments, transmission, remote transmission, audible presentation and visualization may take place in the form of an application program that can be stored on the telecommunications device, i.e., in the form of an “application” (app).

Embodiments of the invention are directed to a method for providing operating instructions and user instructions belonging to a device for sealing and inflating inflatable objects, in particular with a puncture kit for sealing and inflating motor vehicle tires, and necessary for the operation thereof.

In further embodiments, the character string may contain an indexing that, depending on the age, the condition of use or special production features, can insert additional instructions in the operating instructions and user instructions.

Still further, embodiments of the invention are directed to a device for sealing and inflating inflatable devices, in particular, a puncture kit for sealing and inflating motor vehicle tires, provided with a character string for carrying out the above-described method.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates an exemplary technical device having an affixed character string according to embodiments of the invention;

FIG. 2 illustrates the technical device depicted in FIG. 1 with its lid closed to show the affixed character string;

FIG. 3 shows exemplary illustrated instructions for operation of the technical device depicted in FIG. 1 that includes the character string;

FIG. 4 illustrates an exemplary flow diagram of an embodiment of the invention;

FIG. 5 illustrates an exemplary flow diagram of another embodiment of the invention; and

FIG. 6 illustrates an exemplary flow diagram of a further embodiment of the invention.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

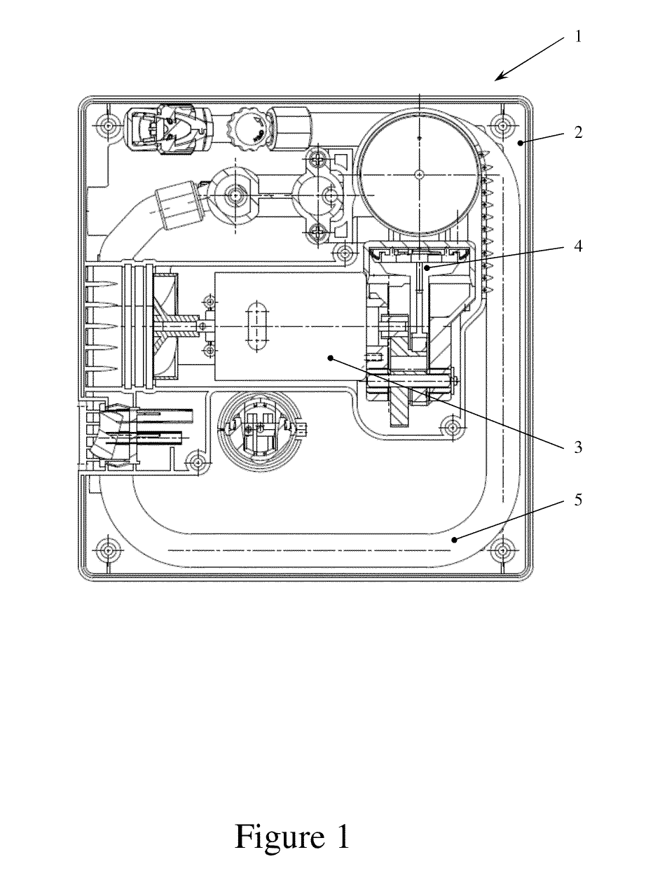

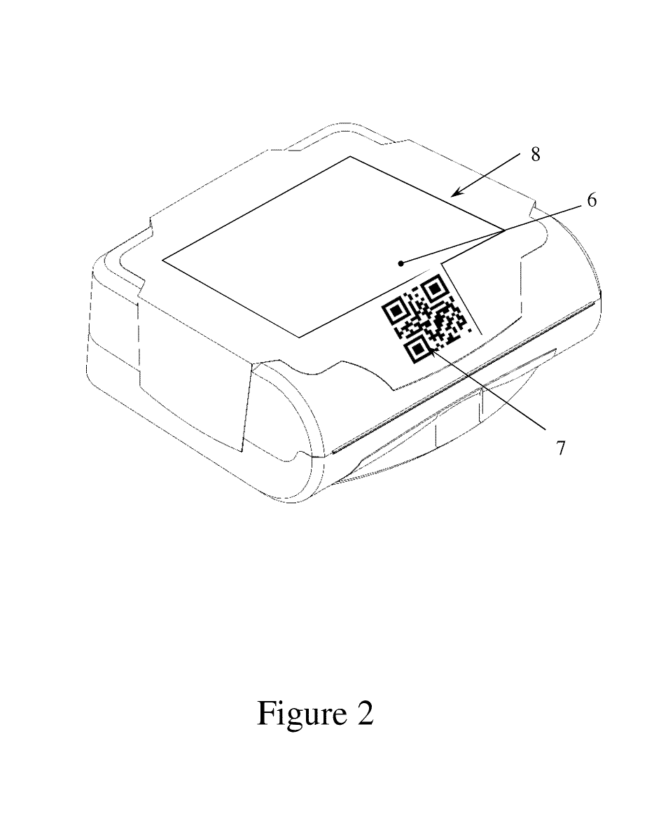

FIGS. 1 and 2 illustrate an exemplary technical device 1 to assist a user in performing a task. In the illustrated embodiment, technical device 1 can be used, e.g., for sealing and/or inflating inflatable objects, in particular, as a puncture kit for sealing and inflating motor vehicle tires. In the embodiment of FIG. 1, technical device 1 is shown in an opened condition so that the working elements of technical device 1 are accessible to the user so that the device can be put into operation. As shown in FIG. 2, a cover or lid 6, which may be completely removable or hingedly removable/openable in the manner of, e.g., a clam shell, can be provided to selectively cover and offer the user access to the working elements.

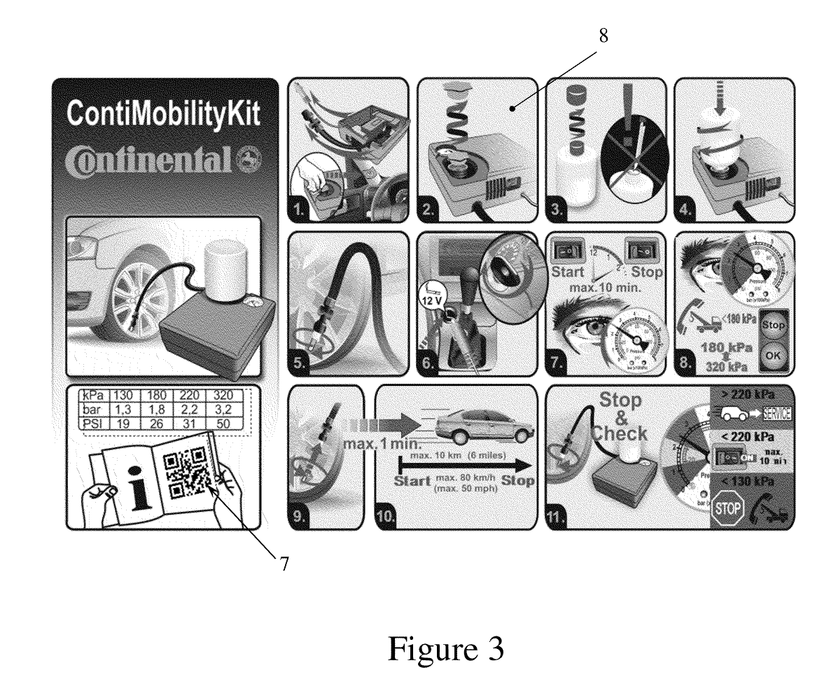

In the embodiment of FIG. 1, cover 6 is removed for ease of illustration and explanation so that working elements of the exemplary technical device 1. With a housing 2, technical device 1 can include a compressor 4 driven by an electric motor 3 as well as a connection for receiving a container with sealant, a valve unit and distributor unit, neither of which is shown in further detail here. Furthermore, technical device 1 can include a hose 5 structured for connection to the valve and distributor unit of technical device 1 and to a valve of the inflatable object. Moreover, technical device 1 can also include a connector, not shown in further detail here, for a power supply and the switching and/or control and display apparatus for the operation of the device. Technical device 1 can also include illustrated brief instructions 8 for emergencies printed on or adhered to cover 6 in the event that network access for the telecommunications device is not available or a power outage (or dead batteries) prevent communication. In embodiments, code 7 can also be printed on the illustrated brief instructions 8, as shown in FIG. 3, to facilitate the user's access to the code in the event that the telecommunications device's access to a network is restored.

It is to be understood that the specific operation of technical device 1 is not the focus of the embodiments of the invention, but rather the acquisition of instructions by the user for operating technical device 1. Thus, it should be understood that the embodiments of the invention are not limited to the illustrated embodiment of technical device 1 and that any technical device can be utilized in conjunction with the embodiments of the invention so as to facilitate a user's operation of a technical device. Thus, in accordance with embodiments of the invention, the user does not need to be technically savvy to adeptly operate the technical device nor is it necessary that the user have any familiarity at all with the specific operation of the technical device in order to properly operate the device in its intended manner. Further, while the embodiments are described with regard to operating a technical device, it is further understood that the embodiments of the invention also contemplate the provisioning of or facilitating the user's access to instructions for product assembly, and that the product can be any product for which assembly instructions are provided.

As shown in FIG. 2, cover 6 can be provided with information 8 in the form of, e.g., a label, sticker, printed or screened text, logos, etc. for identifying technical device 1 and its purpose, e.g., tire repair and inflation kit. Moreover, a code 7 may be printed, adhered or otherwise attached to cover 6. By way of non-limiting example, code 7 may be, e.g., a character string of letters, numbers or a combination of letters and numbers, or embodied or formed as either a one- or two-dimensional a machine-readable code, e.g., a bar code, a matrix code, such as a quick response (QR) code, a data matrix code, or other similar code. Code 7 can be read and/or decoded, e.g., via a telecommunications device equipped with an image collector, which can include, e.g., at least one of a still camera or scanner. By way of non-limiting example, user's telecommunications device can be, e.g., a mobile phone, a smartphone or tablet operating with Android, Blackberry or other similar smartphone operating system, an IPhone or IPad, or other suitable mobile device equipped with an image collector, such as, e.g., a still camera or a scanner. An application (or “app,” such as a scanner app) specially designed to read and/or decode a one- or two-dimensional (matrix) code 7 can be downloaded (for free or at a cost) onto the user's telecommunications device from a website associated with the seller or distributor of technical device 1 or from an application store or similar website or electronic store that provides apps for downloading (for free or at a cost) to smartphones, tablets, IPhones, or IPads and similar devices as the user's telecommunications device.

An icon associated with the scanner application can reside on the display of the telecommunications device to be selectively accessed by the user, e.g., via touching the display in the vicinity of the icon. The scanner application can also include software designed to recognize the pattern/code in code 7 and to decode the data in or associated with code 7. The software is preferably stored in a memory in the telecommunications device, so that the code 7 can be decoded even when network access is not available. By way of non-limiting example, the scanner application can provide a viewfinder and the user can move the telecommunications device until code 7, e.g., a two dimensional code, such as a QR code, is located with the viewfinder. The scanner can automatically sense code 7's presence in the viewfinder or the user may press a designated button or portion of the screen or viewfinder to institute a scanning of code 7 within the viewfinder. The application can further include software to convert or process the scanned image data into a form suitable for decoding the information within or associated with code 7 and then to decode the converted or processed scanned image data in order to retrieve or obtain the information contained within or associated with code 7. The data can preferably be a link to a website (or to a web page or a location within the website) of the seller or distributor specially designed to provide instructions for the operation of technical device 1 that can be shown on the display of the user's telecommunication device.

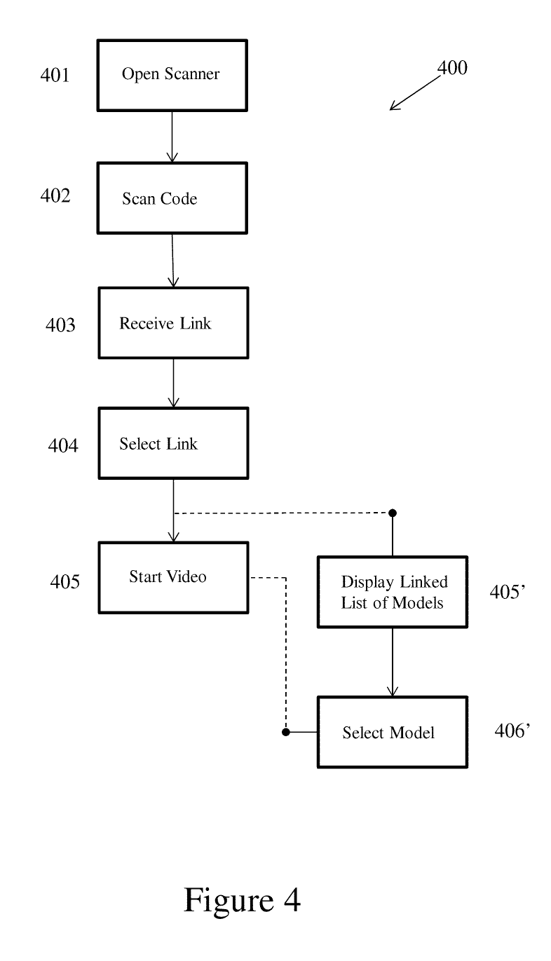

When the user accesses the website link shown on the display, e.g., by clicking on the highlighted or underlined link, a browser in the user's telecommunications device can open and direct the user, through one or more public and/or private networks, cellular networks, satellite networks, the Internet and combinations thereof, to the website (or to a web page or a location within the website) identified in the link obtained from decoding code 7, which generally resides in a memory or server remote from the user. In an exemplary process 400 according to the flow diagram of FIG. 4 generally describes a process for a user to access operating instructions for technical device 1. The user at 401 can open a code scanner by touching or clicking on an icon associated with a code scanner application residing on the display screen of a telecommunications device. At 402, the user manipulates the telecommunications device so that code 7 is within a viewfinder of the code scanner application. The code scanner application automatically reads the code, decodes the information and displays a website or web page link associated with code 7 on the telecommunications device at 403. The user at 404 can select the link by touching or clicking on the displayed link and be routed or directed to a website or to a web page or a location within a website. In the exemplary embodiment, the link may route the user directly to a video operating instructions for technical device 1, which is stored in a specific linked location in a website for the seller or distributor of technical device 1. In this event, once the web page containing the video operating instructions has loaded on the user's telecommunications device, the user may start the video at 405 and watch how to operate technical device 1. This embodiment may be particularly advantageous when the technical device is an emergency kit, such as the tire inflation/repair kit illustrated in FIG. 1, so that, in the event that the user is stopped by a flat tire on a busy roadway, or late at night, or during inclement weather conditions, the user can directly access the operation information to reduce his exposure to other drivers or the elements, and thereby reduce or prevent potential harm to the user as he repairs his tire.

Moreover, it is understood that, as the seller or distributor of technical device 1 may also sell or distribute other models of technical device 1 or other distinct technical devices, unique code can be obtained for each model and for each distinct technical device and affixed to respective models or devices so that the user, upon scanning the code, can be routed or directed to the video operating instructions for the specific model or device for which instructions are needed. Alternatively, it is also contemplated that, in the event that a number of models of technical device 1 are available from the seller or distributor, after selecting the link at 404, the user can be routed or directed to a web page at 405′ that includes a linked list the various models of technical device 1 available. The user can select the appropriate model by touching or clicking on the link associated with the model at issue at 406′, and then the user may routed directly to a video operating instructions for his specific model of technical device 1, which is stored in a specific linked location in a website for the seller or distributor of technical device 1. Once the web page containing the video operating instructions has loaded, the user may start the video at 405 and watch how to operate technical device 1.

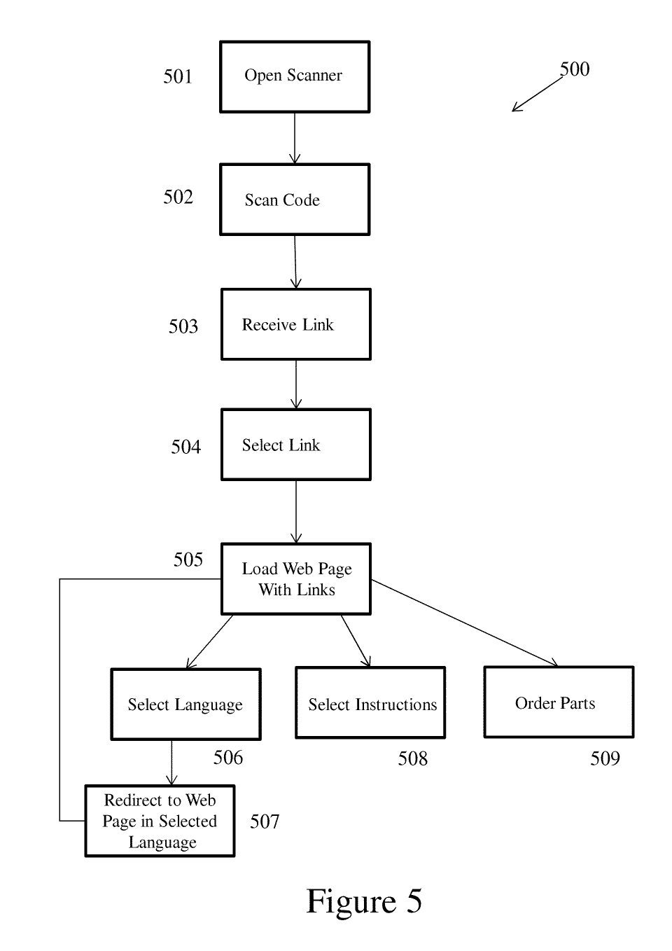

It is further understood that, while a video showing the proper operation of technical device 1 would facilitate and enhance the user's comfort level with operating technical device 1, it may also be advantageous if additional information about technical device 1 were accessible through the scanning of code 7. In an alternative embodiment, a process 500 is illustrated in a flow diagram in FIG. 5. The user at 501 can open a code scanner by touching or clicking on an icon associated with a code scanner application residing on the display screen of a telecommunications device. At 502, the user manipulates the telecommunications device so that code 7 is within a viewfinder of the code scanner application. The code scanner application automatically reads the code, decodes the information and displays a website or web page link associated with code 7 on the telecommunications device at 503. The user at 504 can select the link by touching or clicking on the displayed link and be routed or directed to a website or to a web page or location within a website. In this exemplary embodiment, the link may route the user to a web page that specially designed for users of technical device 1. Upon the loading of the web page, a number of links associated with operation and maintenance of technical device 1 may be listed for the user's review at 505. By way of non-limiting example, the web page may include links for selecting a language, for viewing visual operating instructions for technical device 1, e.g., a video recording, photo series, text (with or without graphic illustrations or photos), etc. showing the proper operation of technical device 1, for ordering replacement parts, etc.

The link for setting the language may display the phrase “set language” or similar phrase in a number of different languages so that the user will understand the link relates to setting the language. Upon selecting this link at 506, the user will routed or directed to a web page displaying the various alternative languages available for translation. When the user selects one of the alternative languages, all succeeding communications and actions can be performed in the selected alternative language. By way of non-limiting example, if the user selects “Deutsch” to set the language to German, the user can be routed or directed to copy of the web page identifying the links associated with the operation and maintenance of technical device 1, except the page is now in the German language at 507. Alternatively, on the page loaded at 505, the national flags of countries whose languages are accommodated can be displayed and may be selectable by the user to set the language, whereupon the user will be routed or directed to a similar page, except in the selected language.

Moreover, in furtherance of this exemplary embodiment, the user at 508 can select to play or view the visual operating instructions. The video, photo series or text may be recorded in any suitable format to be retrieved or downloaded and played/displayed on the user's telecommunication device. To prevent undue overuse of resources, such as memory storage space, the video or photos may preferably be stored in a location remote from the telecommunications device and downloaded to the telecommunications device for playback only. Further, the video, photo series, or text can be a silent recording/display, such that the user is simply shown how to properly (or instructed how to) use technical device 1. As an alternative, a default video can be recorded so that, in addition to the video, photo series, or text showing and/or describing how to properly operate technical device 1, voice instructions in can be recorded in the video or written instructions or annotations can be included on the photos or drawings to provide further assistance to the user. Moreover, alternative copies of the video/voice instructions, as well as the text, can be recorded and stored to provide voice over instructions and/or associated text in each of the available alternative languages. As noted above, once a new language is set, the linked items for selection by the user will be in the selected alternative language.

At 509, the user can select a link to direct the user to an order form so that parts or supplies that may become exhausted during the operation of technical device 1 can be ordered. For example, when technical device 1 is an emergency roadside tire inflation/repair kit, as shown in FIG. 1, an air compressor 4 operable on the vehicle power supply, e.g., a 12V lighter plug, can be used to expel or inject the contents of a cannister containing a tire sealant material into the flat tire. When the entirety or majority of the tire sealant contents of the cannister are expelled or injected into the flat tire, a new cannister may be required before a next use of technical device 1. Of course, it is understood that the cannister or other exhaustable part(s) of technical device 1 may be designed for multiple uses before exhaustion without departing from the spirit and scope of the invention. However, if technical device includes exhaustable parts, replacement will be required at some point, and such replacement parts may be ordered on a web page loaded on the telecommunications device after selecting the maintenance link. Of course, other options can also be included, such as filling out warranty information; registering technical device 1, etc.

While a two-dimensional code can contain more information than one-dimensional codes or other alphanumeric character strings, use of these less robust codes can be utilized in accordance with other embodiments of the invention. In particular, the seller or distributor of technical device can make available for downloading through any of the conventional channels supplying such applications, for free or for a cost, an application for use in conjunction with telecommunications devices. Because the application would only require a code sufficient to identify a specific technical device or model, a one-dimensional code or an alphanumeric character string may be affixed to technical device as code 7. Of course, a two-dimensional code can also be utilized without departing from the spirit and scope of the invention.

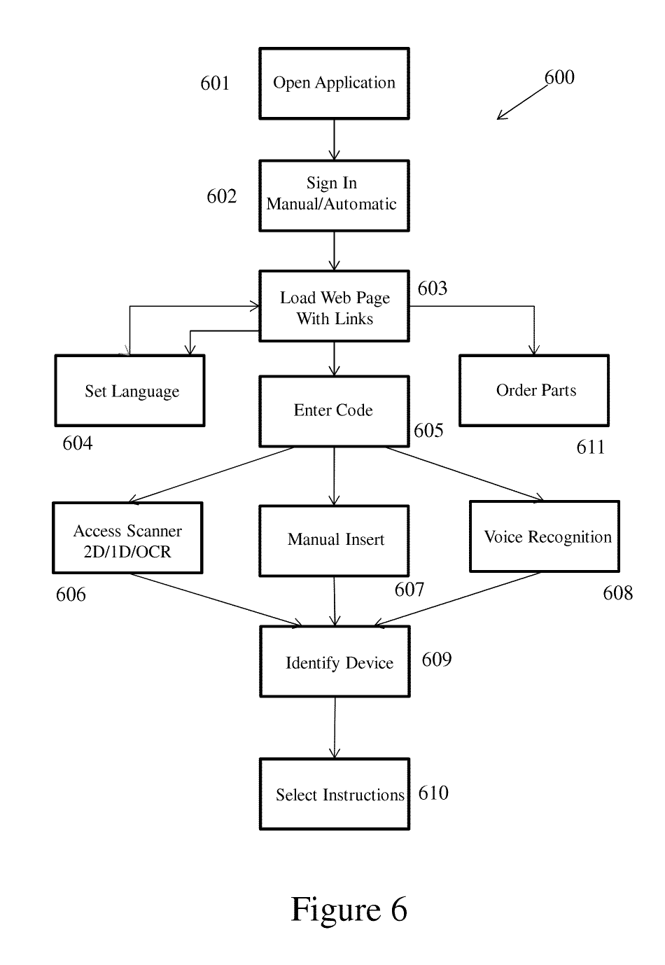

In another alternative embodiment, a process 600 is illustrated in a flow diagram in FIG. 6. The user at 601 can open an application of the seller or distributor of technical device 1 by touching or clicking on an icon associated with a seller/distributor application residing on the display screen of a telecommunications device. When accessing the application for the first time, a user may be prompted to register as a user and/or to register their technical device. At 602, a sign in page may be load onto the telecommunications device, requiring the user to sign in before accessing the application. Alternatively, the sign in procedure can be automatic so that the opening page of the application may automatically load on the telecommunication device without requiring the user to manually sign in. As with the previous embodiment, the opening page may include a number of links associated with operation and maintenance of technical device 1 may be listed for the user's review at 603. Further links can also include, by way of non-limiting example, a link for the user to update personal information, to register additional technical devices of the seller/distributor to be associated with the user, links for selecting a language, and/or links for entering the code affixed to technical device 1.

As described above, the link for setting the language may display the phrase “set language” or similar phrase in a number of different languages so that the user will understand the link relates to setting the language. Upon selecting this link at 604, the user will routed or directed to a web page displaying the various alternative languages available for translation. When the user selects one of the alternative languages, all succeeding communications and actions can be performed in the selected alternative language. Alternatively, on the page loaded at 603, the national flags of countries whose languages are accommodated can be displayed and may be selectable by the user to set the language, whereupon the user will be routed or directed to a similar page, except in the selected language.

In embodiments, the user at 605 can now enter the code affixed to technical device 1 in order to obtain information about the device. By accessing the link at 603 related to entering the code, a web page can be loaded that includes a list of options for entering code 7. By way of non-limiting example, the options can include opening at 606 a two-dimensional scanner; a one-dimensional scanner; or a scanner with optical character recognition for alphanumeric character strings; manually entering an alphanumeric character string at 607; and voice recognition entry of an alphanumeric character string at 608. Further, without departing from the spirit and scope of the invention, icons depicting a generic two-dimensional code and a generic one-dimensional code can be displayed on the loaded web page for selection by the user. As the seller/distributor likely only maintains a limited number of codes for identifying its products, even the one-dimensional codes and alphanumeric character strings can sufficiently identify the specific technical device and/or model associated with the code affixed to the user's technical device 1. In this regard, the codes read by the scanner can be decoded in a conventional manner to identify the encoded information, and the alphanumeric character strings can be read and searched in a relational database to identify the product associated with the character string. While the relational database can be stored in a memory or server remote from the user, it is also conceivable that the database relating various character strings to products/models offered by the seller/distributor could be stored in the telecommunication device.

Once the appropriate technical device or model is identified at 609 via the scan or database search of code 7, the user at 610 can select to play or view the visual operating instructions. As described above, the video, photo series or text may be recorded in any suitable format to be retrieved or downloaded and played/displayed on the user's telecommunication device. It is further understood that the instructions can be in the form of simply a voice/audio file. To prevent undue overuse of resources, such as memory storage space, the video or photos may preferably be stored in a location remote from the telecommunications device and downloaded to the telecommunications device for playback only. However, it is further contemplated that, when registering the technical device through the application, the visual operating instructions can be automatically downloaded and stored onto the telecommunications device. This may be particularly advantageous in a situation in which the user requires assistance in operating the technical device but network access is not available. In this situation, the application would access for playback the visual operating instructions associated with the entered code 7 from the memory of the telecommunication device. As discussed above, the video, photo series, or text can be a silent recording/display, such that the user is simply shown how to properly (or instructed how to) use technical device 1. As an alternative, the video, photo series, or text showing and/or describing how to properly operate technical device 1 can include recorded voice-over instructions or written instructions or annotations provided with the video or photos to provide further assistance to the user. Moreover, the voice and/or text can be recorded in the various languages supported by the application and stored for retrieval based upon the language set by the user. As noted above, once a new language is set, the linked items for selection by the user will be in the selected alternative language.

At 611, the user can access link, e.g., on the web page of links, to direct the user to an order form so that parts or supplies that may become exhausted during the operation of technical device 1 can be ordered. For example, when technical device 1 is an emergency roadside tire inflation/repair kit, as shown in FIG. 1, an air compressor 4 operable on the vehicle power supply, e.g., a 12V lighter plug, can be used to expel or inject the contents of a cannister containing a tire sealant material into the flat tire. When the entirety or majority of the tire sealant contents of the cannister are expelled or injected into the flat tire, a new cannister may be required before a next use of technical device 1. Of course, it is understood that the cannister or other exhaustable part(s) of technical device 1 may be designed for multiple uses before exhaustion without departing from the spirit and scope of the invention. However, if technical device includes exhaustable parts, replacement will be required at some point, and such replacement parts may be ordered on a web page loaded on the telecommunications device after selecting the maintenance link. Of course, other options can also be included, such as filling out warranty information; registering technical device 1, etc.

Although the embodiments of the invention have been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Further, it is understood that features of the various embodiments can be combined without departing from the spirit and scope of the invention.

In accordance with various embodiments of the present invention, the methods described herein can be implementable for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software implementations of the embodiments of the present invention may be optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Accordingly, replacement standards and protocols having the same functions are considered equivalents.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A method for providing product instructions to a user of a telecommunications device through at least one network, the method comprising:
placing a code on or in a vicinity of the product;
storing instructions in a memory of a server located remotely from the telecommunications device;
receiving, from decoded data of the code, a request to download the instructions for the product to the telecommunications device; and
transmitting the instructions for playback on the telecommunications device.

2. The method according to claim 1, wherein the product instructions comprise at least one of operating instructions and assembly instructions.

3. The method according to claim 1, wherein the instructions are at least one of a visual recording and an audible recording.

4. The method according to claim 3, wherein the visual recording comprises video instructions depicting at least one of correct operation of the product and correct assembly of the product; and
wherein the audible recording comprises a voice recording of at least one of correct operation of the product and correct assembly of the product.

5. The method according to claim 3, wherein the video instructions includes written text.

6. The method according to claim 5, wherein a language for the playback of the audible recording is selectable by a user of the telecommunications device.

7. The method according to claim 1, wherein the code comprises at least one of a one- or two-dimensional machine-readable code and an alphanumeric character string.

8. The method according to claim 1, wherein the code comprises one of a bar code or quick response code (QR code).

9. The method according to claim 1, wherein the code is decodable via at least one of a camera and a scanner of the telecommunications device.

10. The method according to claim 1, wherein the product comprises a device for sealing and inflating inflatable objects.

11. The method according to claim 10, wherein the device comprises a puncture kit for sealing and inflating motor vehicle tires.

12. The method according to claim 1, further comprising receiving a request for replacement parts for the product.

13. A system providing product instructions to a user of a telecommunications device through at least one network, the system comprising:
a code placed on or in a vicinity of the product;
instructions stored in a memory of a server located remotely from the telecommunications device;
a processor structured and arranged to receive, from decoded data of the code, a request to download the instructions for the product to the telecommunications device; and
a transmitting unit structured and arranged to transmit the instructions for playback on the telecommunications device.

14. The system according to claim 13, wherein the product instructions comprise at least one of operating instructions and assembly instructions.

15. The system according to claim 13, wherein the instructions are at least one of a visual recording and an audible recording, and
wherein the visual recording comprises video instructions depicting at least one of correct operation of the product and correct assembly of the product; and the audible recording comprises a voice recording of at least one of correct operation of the product and correct assembly of the product.

16. The system according to claim 15, wherein the video instructions includes written text.

17. The system according to claim 16, wherein a language for the playback of the audible recording is selectable by a user of the telecommunications device.

18. The system according to claim 13, wherein the code comprises at least one of a bar code or quick response code (QR code).

19. The system according to claim 13, wherein the code is decodable via at least one of a camera and a scanner of the telecommunications device.

20. The system according to claim 13, wherein the device comprises a puncture kit for sealing and inflating motor vehicle tires.
